(19) United States
(12) Patent Application Publication
(10) Pub. No.: US 2022/0382428 A1
(43) Pub. Date: Dec. 1, 2022

(54) METHOD AND APPARATUS FOR CONTENT PREVIEW

(71) Applicant: SAMSUNG SDS CO., LTD., Seoul (KR)

(72) Inventor: Bo Young PARK, Seoul (KR)

(21) Appl. No.: 17/826,634

(22) Filed: May 27, 2022

(30) Foreign Application Priority Data
May 28, 2021 (KR) 10-2021-0069135

(51) Int. Cl. G06F 3/0488; G06F 3/0482; G06F 3/0346

(52) U.S. Cl. CPC G06F 3/0488; G06F 3/0482; G06F 3/0346

(57) ABSTRACT

A content preview method according to an embodiment of the present disclosure includes displaying a first preview screen for first content according to an input of a preview touch gesture, detecting a preview event for a second content item included in the first preview screen while the touch input is maintained, and displaying a second preview screen including detailed information on the second content in response to the detection of the preview event.

### CROSS-REFERENCE TO RELATED APPLICATION(S) AND CLAIM OF PRIORITY

This application claims priority from Korean Patent Application No. 10-2021-0069135 filed on May 28, 2021, in the Korean Intellectual Property Office, the disclosure of which is incorporated herein by reference in its entirety.

### BACKGROUND

### 1. Field of the Disclosure

The present invention relates to a content preview method and apparatus for previewing detailed information on content, and more particularly, to a content preview method and apparatus for previewing a plurality of pieces of content through a single touch gesture.

### 2. Description of the Related Art

Users may search for various pieces of content by using a communication device such as a mobile terminal or a tablet computer and see the details of their desired content. In order to confirm desired content, users may repeat the execution and interruption of the content until the desired content is confirmed in a content list.

In order to minimize the repetition of such content execution and interruption, a content preview function has been developed and applied. For example, when a preview manipulation signal for content is input, a preview screen for the content is displayed. However, even if a conventional content preview function is used, a user can preview only one piece of content using a single touch gesture. Thus, in order to preview a plurality of pieces of content, a user should input a number of touch gestures corresponding to the number of pieces of content to a communication device.

A scheme that requires multiple touch inputs to preview each piece of content causes inconvenience to users.

### SUMMARY

A technical aspect to be achieved by the present invention is to provide a content preview method and apparatus for previewing a plurality of pieces of content through a single touch gesture.

Another technical aspect to be achieved by the present invention is to provide a content preview method and apparatus for previewing content of a lower depth hierarchically linked to a current webpage.

Still another technical aspect to be achieved by the present invention is to provide a content preview method and apparatus with enhanced convenience.

The technical aspects of the present invention are not limited to those described above, and other aspects that are not described herein will be apparently understood by those skilled in the art from the following description.

According to an aspect of the inventive concept, there is provided a content preview method performed by a computing device. The content preview method includes operations of displaying a first preview screen for first content according to an input of a preview touch gesture, detecting a preview event for a second content item included in the first preview screen while the touch input is maintained, and displaying a second preview screen including detailed information on the second content in response to the detection of the preview event.

The operation of detecting the preview event may include operations of receiving a touch input of swiping to the second content item included in the first preview screen while the touch input is maintained, and determining that the preview event is detected when the touch input for the second content item is maintained for a predetermined period of time.

The operation of detecting the preview event may include an operation of visually displaying a touch input time for the second content item.

The operation of visually displaying the touch input time may include an operation of visually expressing a progress rate with respect to the touch input time, which has to be maintained for the preview event to be generated, on a border of the second content item.

The operation of detecting the preview event may include operations of receiving a touch input of swiping to the second content item included in the first preview screen while the touch input is maintained, and determining that the preview event is detected when a first motion is detected while the touch input of swiping to the second content item is maintained.

The first motion may be a motion in which the computing device is tilted in a first direction.

The operation of detecting the preview event may include operations of receiving a touch input of swiping to the second content item included in the first preview screen while the touch input is maintained, and determining that the preview event is detected when a three-dimensional (3D) touch input for the second content item is received.

The content preview method may further include operations of detecting a second motion when the second preview screen is displayed, and displaying the first preview screen in response to the detection of the second motion.

The second motion may be a motion in which the computing device is tilted in a second direction.

According to an aspect of the inventive concept, there is provided a content preview method performed by a computing device. The content preview method includes operations of displaying an n^{th}-order preview screen for n-depth content (here, n is a natural number), detecting a preview event for an (n+1)-depth content item included in the preview screen, and displaying an (n+1)^{th}-order preview screen including detailed information on (n+1)-depth content in response to the detection of the preview event.

The operation of detecting the preview event may include operations of receiving a touch input of swiping to the (n+1)-depth content item included in the n^{th}-order preview screen while the touch input is maintained, and determining that the preview event is detected when the touch input of swiping to the (n+1)-depth content item is maintained for a predetermined period of time.

The content preview method may further include operations of displaying a menu for moving to each preview screen, identifying a preview screen selected from the menu; and displaying the identified preview screen.

The operation of displaying the menu may include an operation of, when the menu is touched, spreading out a plurality of options for selecting the preview screens in a predetermined area, and the operation of identifying the preview screen includes an operation of selecting one of the plurality of options.

The operation of detecting the preview event may include operations of detecting a motion related to preview screen movement, displaying a preview screen of a lower depth on the basis of the depth of a currently displayed preview screen when the detected motion is determined as a first motion, and displaying a preview screen of a higher depth on the basis of the depth of the currently displayed preview screen when the detected motion is determined as a second motion.

The content preview method may further include operations of identifying a last touched preview screen when the touch input is terminated, and displaying the identified preview screen on the full screen.

According to an aspect of the inventive concept, there is provided a computing device that includes one or more processors, a memory configured to load a computer program performed by the processors, and a storage configured to store the computer program, wherein the computer program includes instructions for performing operations of displaying a first preview screen for first content according to an input of a preview touch gesture, detecting a preview event for a second content item included in the first preview screen while the touch input is maintained, and displaying a second preview screen including detailed information on the second content in response to the detection of the preview event.

The operation of detecting the preview event may include operations of receiving a touch input of swiping to the second content item included in the first preview screen while the touch input is maintained, and determining that the preview event is detected when the touch input for the second content item is maintained for a predetermined period of time.

The operation of detecting the preview event may include an operation of visually displaying a touch input time for the second content item.

The operation of visually displaying the touch input time may include an operation of visually expressing a progress rate with respect to the touch input time, which has to be maintained for the preview event to be generated, on a border of the second content item.

The operation of detecting the preview event may include operations of receiving a touch input of swiping to the second content item included in the first preview screen while the touch input is maintained, and determining that the preview event is detected when a first motion is detected while a touch input of swiping to the second content item is maintained.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram showing a configuration of a content preview system according to an embodiment of the present invention;

FIG. 2 is a flowchart of a content preview method according to another embodiment of the present invention;

FIGS. 3A to 3E are diagrams illustrating a screen in which content of each depth is displayed in a preview form;

FIG. 4 is a diagram illustrating an embodiment for operation S160 described with reference to FIG. 2;

FIGS. 5A to 5D are diagrams showing various examples in which a progress rate with respect to a touch input time is visually expressed;

FIG. 6 is a diagram illustrating another embodiment for operation S160 described with reference to FIG. 2;

FIG. 7 is a diagram illustrating a first motion of a user terminal;

FIG. 8 is a diagram illustrating still another embodiment for operation S160 described with reference to FIG. 2;

FIG. 9 is a flowchart of a content preview method according to still another embodiment of the present invention;

FIG. 10 is a diagram illustrating an embodiment for operation S220 described with reference to FIG. 9;

FIG. 11 is a diagram illustrating a menu from which a preview screen may be selected;

FIG. 12 is a diagram illustrating another embodiment for operation S220 described with reference to FIG. 9;

FIG. 13 is a diagram illustrating a second motion of a user terminal;

FIGS. 14A to 14C are diagrams illustrating application of a content preview method to an email;

FIGS. 15A to 15D are diagrams illustrating application of a content preview method to a chat message; and

FIG. 16 is an exemplary configuration diagram of hardware in which a computing device may be implemented in various embodiments.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various embodiments of the present disclosure will be described in detail with reference to the accompanying drawings.

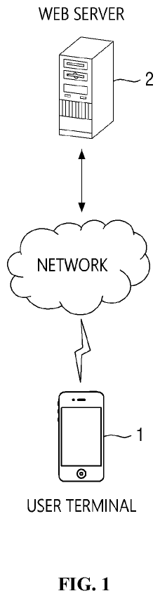

FIG. 1 is a diagram showing a configuration of a content preview system according to an embodiment of the present invention.

As shown in FIG. 1, the content preview system may include a user terminal 1 and a web server 2.

The web server 2 may provide various content such as email, videos, text messages, Internet news, and product information to a content user terminal 1. When receiving a specific search word from the content user terminal 1, the web server 2 may transmit search results found through this search word to the user terminal 1. Also, the web server 2 may provide an email list transmitted by a user or received by a user to the user terminal 1. When specific content is requested by the user terminal 1, the web server 2 may provide some or all of the content to the user terminal 1. Also, the web server 2 may provide information on content necessary for previewing the content to the user terminal 1.

The user terminal 1 is a computing device having a touch screen, such as a smartphone or a tablet computer, and may preview a plurality of pieces of content through a single touch gesture. While a content list including a plurality of content items is received from the web server 2, the user terminal 1 may receive a preview touch gesture that requires a preview of specific content included in the content list. In this case, the user terminal 1 may acquire detailed information on the specific content corresponding to the touch gesture and may display a preview screen of the content including the detailed information in a predetermined preview area. The preview area may be an area corresponding to a portion of the full screen. In an embodiment, the preview touch gesture may be a long touch in which the touch input is maintained for a predetermined period of time. Also, when a preview touch gesture for another content item being displayed in the preview area is input while the touch input is maintained, the user terminal 1 may display a preview screen of the other content in the preview area.

According to this embodiment, by providing previews of a plurality of pieces of content through a single preview touch gesture, it is possible to relieve the inconvenience of repeatedly performing a touch input to preview the plurality of pieces of content.

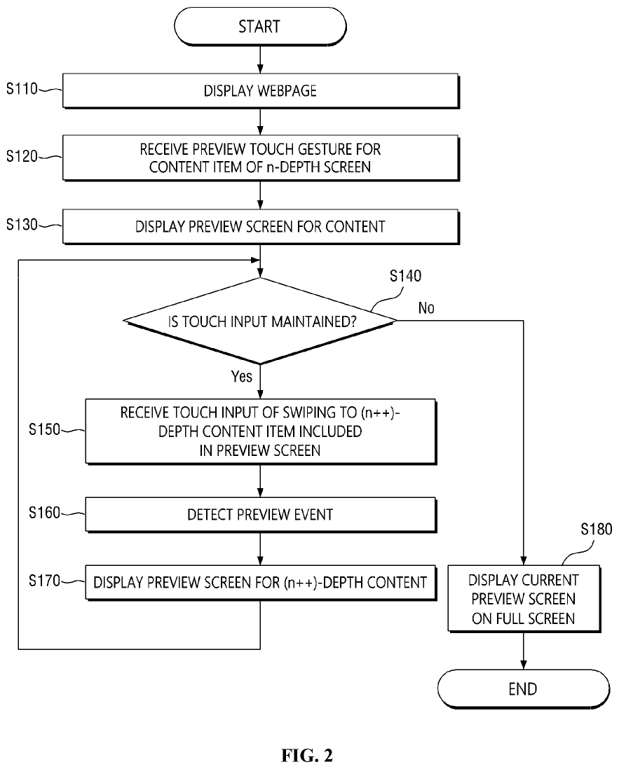

So far, the content preview system according to an embodiment of the present invention has been described with reference to FIG. 1. A content preview method according to another embodiment of the present invention will be described below with reference to FIGS. 2 to 8.

FIG. 2 is a flowchart of a content preview method according to another embodiment of the present invention.

Each operation of the method shown in FIG. 2 may be performed by a computing device. In other words, each operation of the method may be implemented with one or more instructions executed by a processor of the computing device. First operations included in the method may be performed by a first computing device, and second operations of the method may be performed by a second computing device. The following description assumes that each operation of the method is performed by the user terminal 1 described with reference to FIG. 1. An entity that performs each operation is just an example, and the present invention is not limited by the following description. For convenience of description, entities that perform some operations included in the method may be omitted.

Referring to FIG. 2, the user terminal 1 may receive a webpage from the web server 2 and display the webpage (S110). In some embodiments, the user terminal 1 may display a content list that is locally stored. For example, the user terminal 1 may display a list of incoming and outgoing messages, instant chat messages, a video list, and the like.

Subsequently, the user terminal 1 may receive a preview touch gesture for an item of content (i.e., n+1 content) included in an n-depth screen from a user (S120). In an embodiment, the user terminal 1 may receive, as a preview touch gesture, a long touch for a specific content item of the n-depth screen from the user. Here, the depth indicates a hierarchically linked content layer position based on the uppermost content. 0-depth content indicates the uppermost content, 1-depth content indicates content linked to the uppermost content, and 2-depth content indicates content linked to 1-depth content. Also, the 0-depth screen is a screen in which the uppermost content is displayed and may include one or more 1-depth content items, and the 1-depth screen is a screen in which the 1-depth content linked to the uppermost content is displayed and may include one or more 2-depth content items. Also, the 2-depth screen is a screen in which the 2-depth content is displayed and may include one or more 3-depth content items.

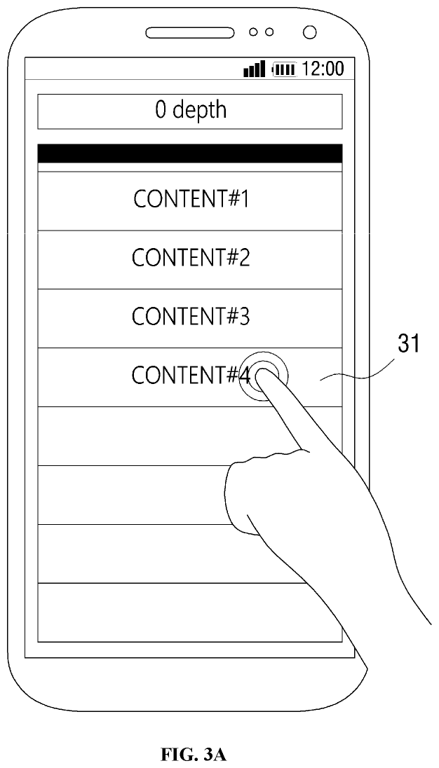

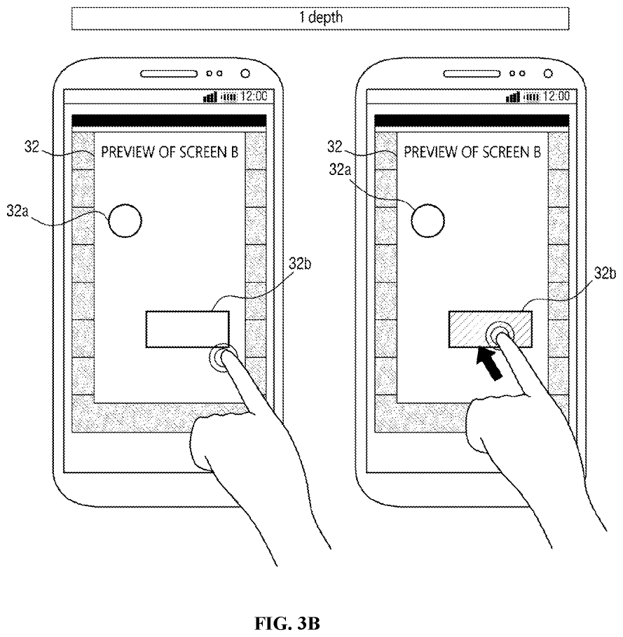

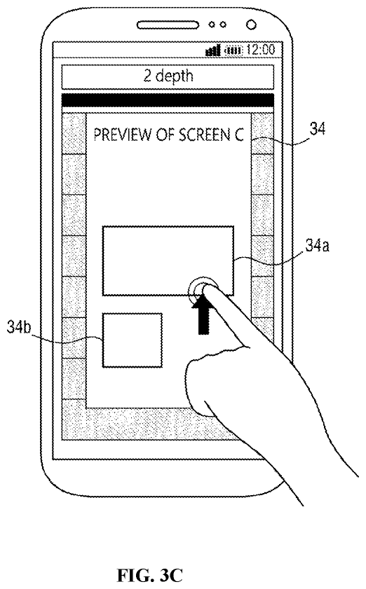

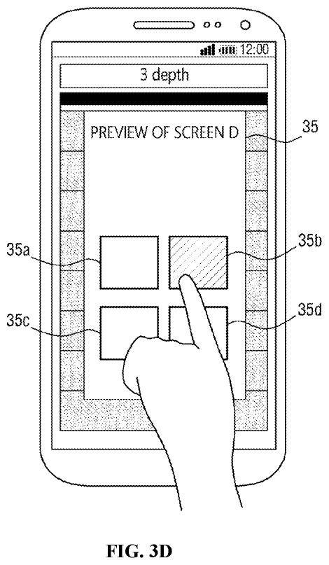

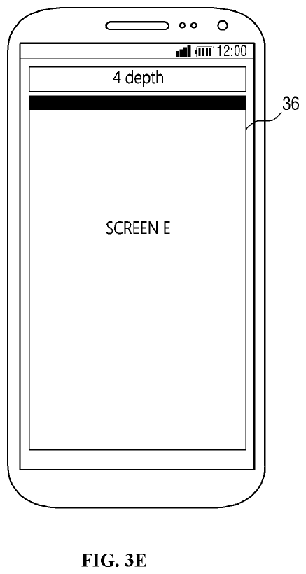

FIGS. 3A to 3E are diagrams illustrating a screen in which content of each depth is displayed in a preview form. FIG. 3A illustrates a screen 31 on which 0-depth content is displayed, and the screen 31 may include 1-depth content items (content #1 to #4). FIG. 3B illustrates a preview screen 32 on which 1-depth content is displayed, and the screen 32 may include 2-depth content items 32a and 32b. Also, FIG. 3C illustrates a preview screen 34 of 2-depth content, and the screen 34 may include 3-depth content items 34a and 34b. FIG. 3D illustrates a screen 35 on which 3-depth content is displayed, and the screen 35 may include 4-depth content items 35a, 35b, 35c, and 35d. FIG. 3E illustrates a screen 36 of 4-depth content

Next, the user terminal 1 may identify a content item for which a preview touch gesture is input (i.e., an (n+1)-depth content item) and may display a preview screen for the identified content (i.e., n+1 content) (S130). In this case, the user terminal 1 may display the preview screen in a preset preview area. Also, after acquiring detailed information on the (n+1)-depth content, the user terminal 1 may configure the preview screen on the basis of the acquired detailed information. The user terminal 1 may acquire the detailed information on the (n+1)-depth content from a local storage area or from the web server 2.

Referring to FIG. 3A, when a preview touch gesture (e.g., a long touch) for an item 31 of content #4, which is one piece of 1-depth content while a 0-depth screen is displayed, is input, the user terminal 1 may generate a preview screen of the content #4 and display the preview screen in the preview area.

Subsequently, the user terminal 1 may determine whether the touch input is maintained (S140). That is, the user terminal 1 may determine whether or not the user's hand is continuously in contact with the touch screen.

While a result of the determination in operation S140 is that the touch input is continuously maintained, the user terminal 1 may receive a touch input of swiping to an (n++)-depth content item included in the currently displayed preview screen.

Next, the user terminal 1 may detect a preview event for the (n++)-depth content item on the basis of at least one of a 3D touch input, a motion of the user terminal 1, and a touch input time for the (n++)-depth content item (i.e., a long touch or not) (S160). Subsequently, when the preview event for the (n++)-depth content item is detected, the user terminal 1 may identify the (n++)-depth content corresponding to the content item, configure the preview screen for the identified (n++)-depth content, and display the preview screen in the preview area (S170). In an embodiment, a preview screen of the previous depth being displayed may be replaced with the (n++)-depth preview screen.

Subsequently, the user terminal 1 may perform operation S140 again, determine whether a lower-depth preview event is detected when the touch input is continuously maintained, and display a preview screen for the lower-depth preview event according to a result of the determination.

As illustrated in FIG. 3B, while a 1-depth preview screen is displayed, the user terminal 1 may receive a touch input of swiping to the 2-depth content item 32b included in the 1-depth preview screen from the user. In this case, as shown in FIG. 3C, the user terminal 1 may display a 2-depth content preview screen 34 corresponding to the 2-depth content item 32b. Also, while the 2-depth preview screen 34 shown in FIG. 3C is displayed and the touch input is maintained, the user terminal 1 may receive a touch input of swiping to the 3-depth content item 34a from the user. In this case, as shown in FIG. 3D, the user terminal 1 may display a 3-depth content preview screen 35 corresponding to the 3-depth content item 34a in the preview area.

Meanwhile, when the user's touch input is not maintained in operation S140, the user terminal 1 may display, on the full screen, a preview screen that has been displayed in the preview area (S180).

Subsequently, while the 3-depth preview screen 35 shown in FIG. 3D is displayed and the touch input is maintained, the user terminal 1 may receive a touch input of swiping to the 4-depth content item 35b from the user. In this case, the user terminal 1 may display a preview screen for 4-depth content corresponding to the 4-depth content item 35b. When the user's touch input is stopped while the preview screen for the 4-depth content is displayed, the user terminal 1 may display the preview screen for the 4-depth content on the full screen 36 as shown in FIG. 3E.

According to this embodiment, through a single touch input, it is possible to provide a preview for content included in each depth, thereby enhancing convenience in previewing content. Also, according to this embodiment, it is possible to preview lower content included in previewed content.

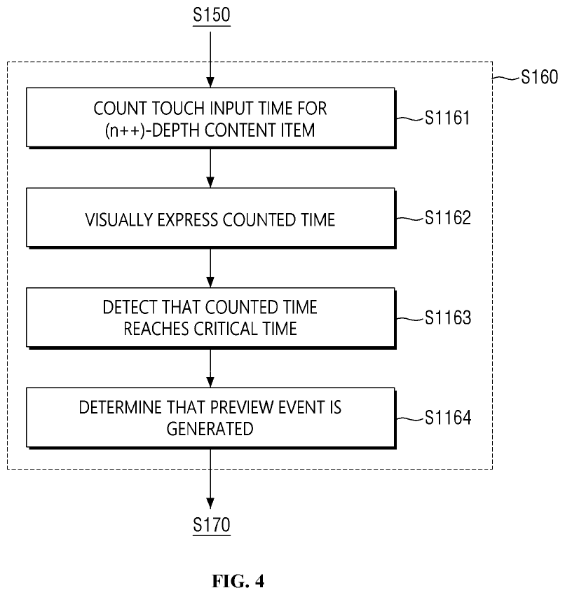

Various embodiments for operation S160 described with reference to FIG. 2 will be described in detail below with reference to FIGS. 4 to 8.

Referring to FIG. 4, the user terminal 1 may count a touch input time for an (n++)-depth content item (S1161).

Subsequently, the user terminal 1 may visually express the counted time (S1162). In an embodiment, the user terminal 1 may visually express a progress rate with respect to the touch input time, which has to be maintained in order for the preview event to be generated. In an embodiment, the user terminal 1 may visually express a progress rate with respect to the touch input time on the border of the content item. In some embodiments, the user terminal 1 may visually express the counted time using a figure representing a progress rate, such as a progress bar or a progress circle.

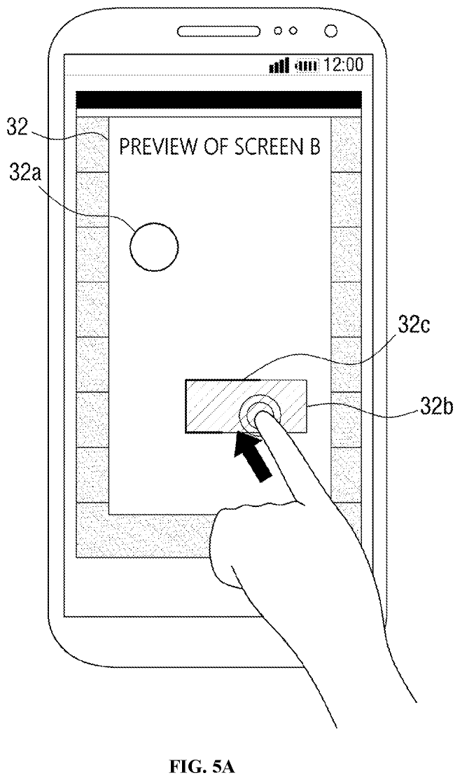

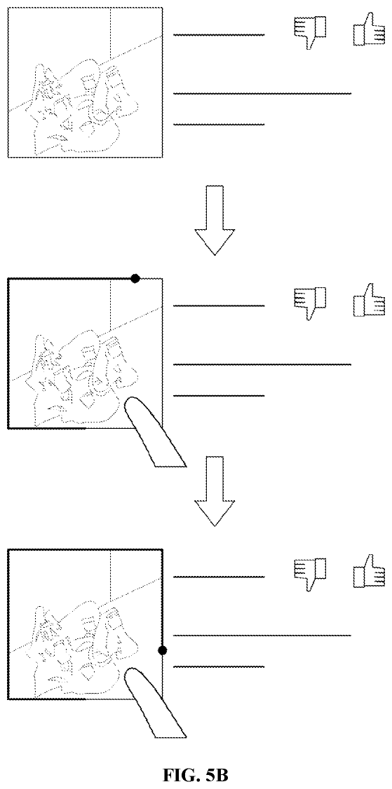

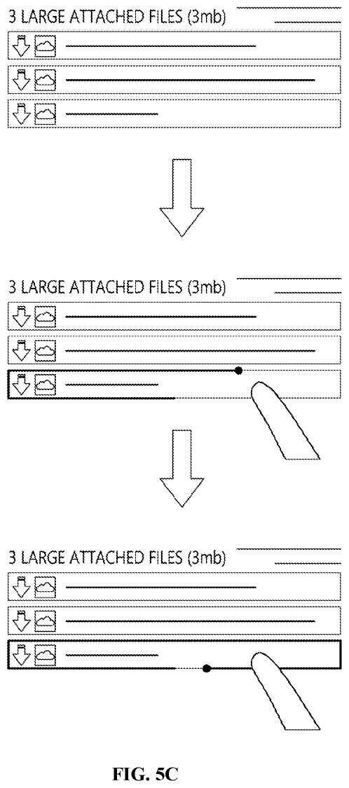

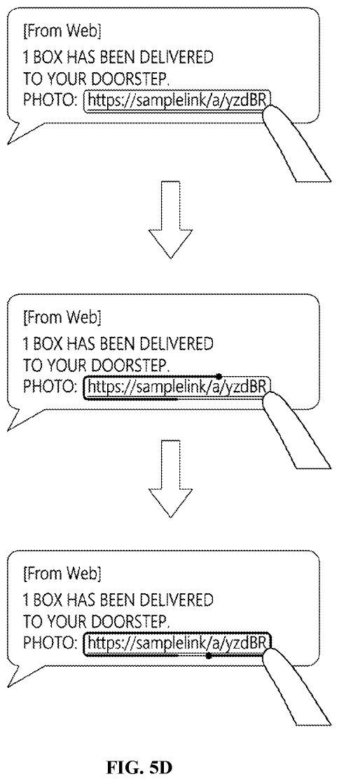

FIGS. 5A to 5D are diagrams showing various examples in which a progress rate with respect to a touch input time is visually expressed.

Referring to FIG. 5A, when a touch input for the 2-depth content item 32b is input to the 1-depth preview screen 32, the user terminal 1 may visually express a progress rate proportional to the touch input time on the border of the content item 32b. The whole border (i.e., a rectangular border) of the content item 32b may indicate a progress rate of 100% in order for the preview event to be generated. The rate at which the touch input time reaches a predetermined time may be visually displayed on the border. That is, according to the touch input time for the content item 32b, the border of the content item 32b may be surrounded by a line of a predetermined color, and the line may be extended from the border of the content item 32b in proportion to an input time. When the line covers the entire border of the content item 32b, the progress rate of the preview event may be 100%. When the progress rate is 100%, it may be determined that the preview event for the content item 32b is generated.

FIG. 5B visually illustrates the progress rate of a preview event for an image content item, and a line surrounding an image border may be extended in proportion to the touch input time.

FIG. 5C visually illustrates the progress rate of a preview event for a file attached to an email, and a line surrounding the border of the attached file item may be extended in proportion to the touch input time.

FIG. 5D illustrates the progress rate of a preview event for a uniform resource locator (URL) link included in a text message, and a line surrounding the border of the URL item may be extended in proportion to the touch input time.

Referring to FIG. 4 again, the user terminal 1 may detect that the counted time reaches a preset critical time (S1163). Subsequently, the user terminal 1 may determine that a preview event for the (n++)-depth content item is generated as the touch input time reaches the critical time (S1164).

According to this embodiment, the user may preview lower-depth content using a swipe touch and a long touch. Accordingly, through a single touch input, it is possible to conveniently preview even lower-depth content.

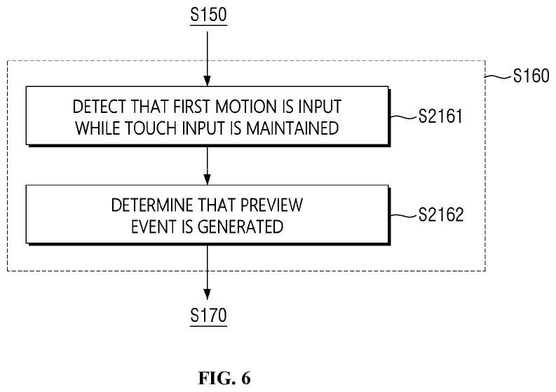

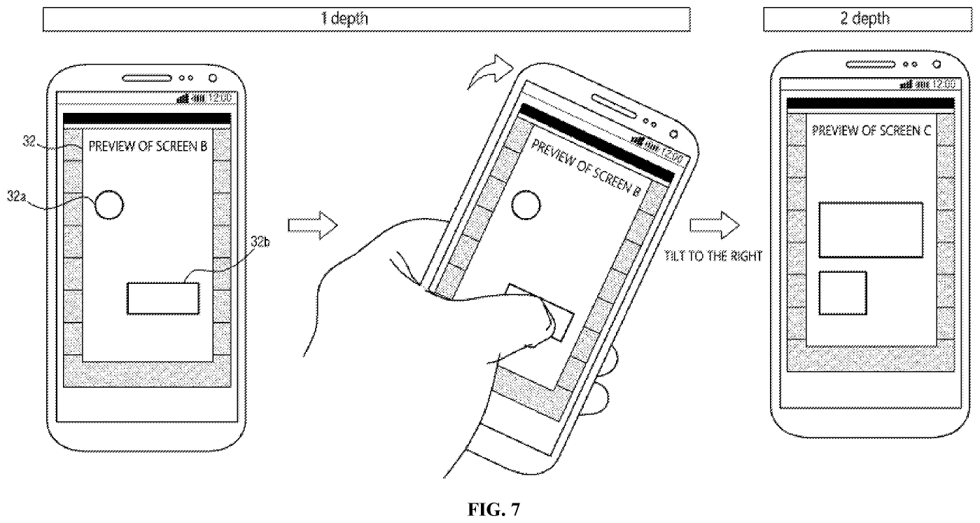

Another embodiment for operation S160 described with reference to FIG. 2 will be described below with reference to FIGS. 6 and 7.

Referring to FIG. 6, the user terminal 1 may detect that a preset first motion is input while a touch input for the (n++)-depth content item is maintained (S2161).

The first motion may be a motion in which the user terminal 1 is tilted in a first direction. In other words, the user terminal 1 may include a gyro sensor and the like and may determine whether the user terminal 1 is tilted in the first direction using the gyro sensor and the like.

FIG. 7 is a diagram illustrating the first motion of the user terminal, and as illustrated in FIG. 7, while a touch input for the 2-depth content item 32b is maintained in the 1-depth preview screen 32, the user terminal 1 may detect the first motion in which the user terminal 1 is tilted in the first direction (e.g., to the right) by a predetermined angle or more.

Subsequently, the user terminal 1 may determine that a preview event for the (n++)-depth content item is generated as the first motion is detected while the touch input for the (n++)-depth content item is maintained (S2162).

According to this embodiment, by detecting a preview event on the basis of the motion of the user terminal 1, it is possible to enhance user convenience in performing the preview of the content.

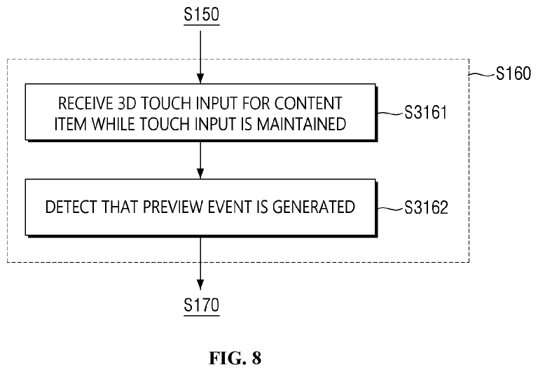

Still another embodiment for operation S160 described with reference to FIG. 2 will be described below with reference to FIG. 8.

Referring to FIG. 8, the user terminal 1 may receive a three-dimensional (3D) touch input for the (n++)-depth content item from the user while the touch input is maintained (S3161). The 3D touch input may be a touch input pressed over a predetermined pressure. To this end, the user terminal 1 may include a touchscreen having a pressure sensor capable of measuring a touch pressure value.

Subsequently, the user terminal 1 may determine that a preview event for the (n++)-depth content item is generated as a 3D touch for the (n++)-depth content item is received from the user while the touch input is maintained (S3162).

According to this embodiment, by detecting a preview event on the basis of the 3D touch input, it is possible to enhance user convenience in performing the preview of content.

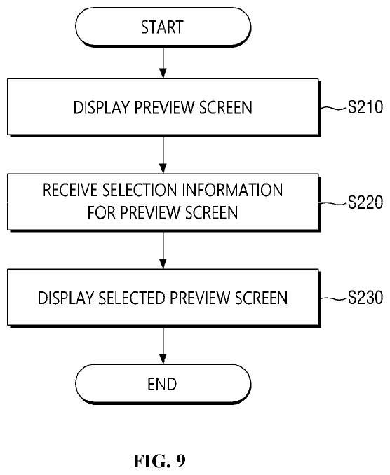

A content preview method according to still another embodiment of the present invention will be described below with reference to FIGS. 9 to 13.

Each operation of the method shown in FIG. 9 may be performed by a computing device. In other words, each operation of the method may be implemented with one or more instructions executed by a processor of the computing device. First operations included in the method may be performed by a first computing device, and second operations of the method may be performed by a second computing device. The following description assumes that each operation of the method is performed by the user terminal 1 described with reference to FIG. 1. An entity that performs each operation is just an example, and the present invention is not limited by the following description. For convenience of description, entities that perform some operations included in the method may be omitted.

Referring to FIG. 9, the user terminal 1 may display an n-depth preview screen (S210).

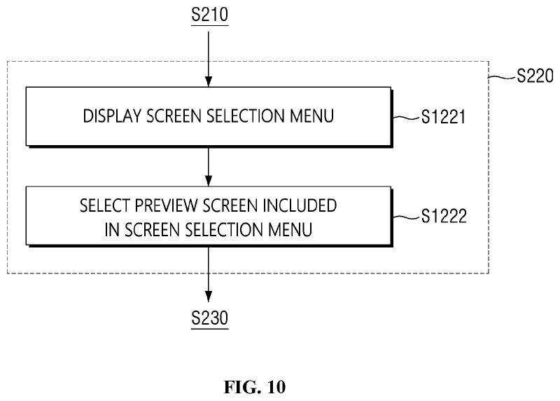

Next, the user terminal 1 may receive, from the user, selection information on a preview screen of another depth from the user while the n-depth preview screen is displayed (S220). In other words, a plurality of preview screens that have already been provided may be displayed again according to the user's selection. That is, the user terminal 1 may display a preview screen matching the user's selection from among the plurality of previously displayed preview screens. Various embodiments for operation S220 in which the selection information is received will be described in detail with reference to FIGS. 10 to 13.

Subsequently, the user terminal 1 may display a preview screen of another depth selected by the user (S230). In an embodiment, the selected preview screen of another depth may be displayed in the preview area. In some embodiments, the selected preview screen of another depth may be displayed on the full screen.

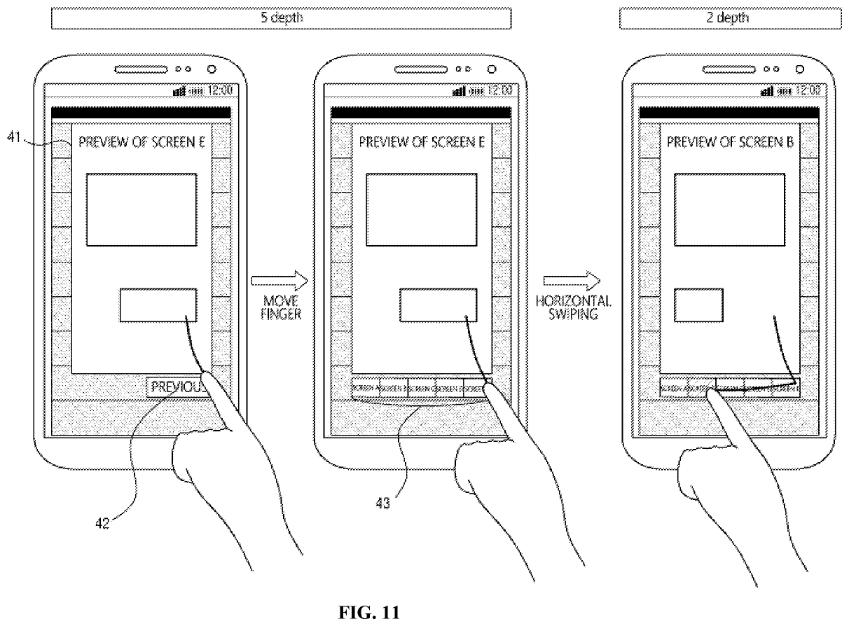

Another embodiment for operation S220 described with reference to FIG. 9 will be described below with reference to FIGS. 10 and 11.

Referring to FIGS. 10 and 11, the user terminal 1 may display a screen selection menu (S1221). The screen selection menu may include options for moving to preview screens provided so far, and the user may select any one of the options.

Subsequently, any one of the options included in the screen selection menu may be selected by the user, and a preview screen corresponding to the selected option may be determined as a screen to be displayed (S1222).

As illustrated in FIG. 11, a menu 42 of a predetermined size for selecting a preview screen may be included in a lower region of the preview screen. When the user selects the menu 42, options 43 of the preview screen are spread out. By selecting any one of the options 43, the user may select a preview screen that he or she wants to see again.

In an embodiment, the menu 42 may be displayed while the user's touch input is maintained. In this case, the user may cause the options 43 to be spread out after performing a touch swipe to the menu 42, and after the options are spread out, the user may swipe and touch one of the options. In another embodiment, the menu 42 may be displayed even when the user's touch input is not maintained. In this case, the user may cause the options to be spread out by tapping on the menu 42 and may tap on and select any one option after the options 43 are spread out. FIG. 11 illustrates that a preview screen corresponding to screen B is displayed by screen B selected from the option.

According to this embodiment, it is possible to easily change a preview screen on the basis of a selection menu for changing a preview screen.

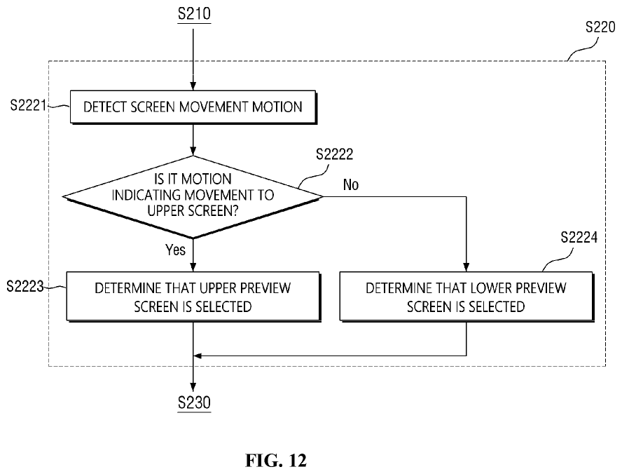

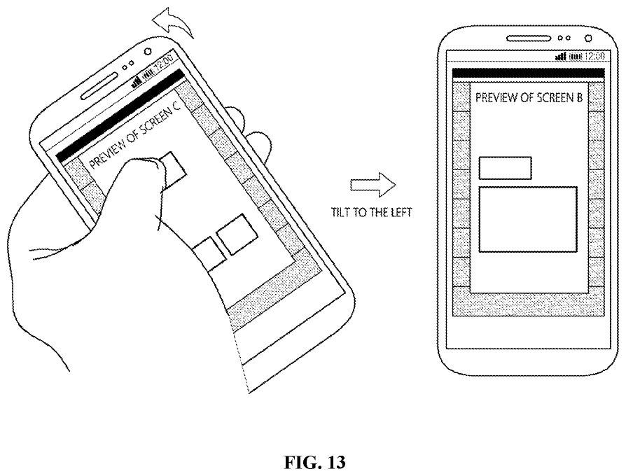

Another embodiment for operation S220 described with reference to FIG. 9 will be described below with reference to FIGS. 12 and 13.

Referring to FIGS. 12 and 13, the user terminal 1 may detect a motion related to screen movement while the n-depth preview screen is displayed (S2221). The motion related to the screen movement may include a first motion and a second motion. The first motion may be a motion in which the user terminal 1 is tilted in a first direction (e.g., to the right), and the second motion may be a motion in which the user terminal 1 is tilted in a second direction (e.g., to the left). The user terminal 1 may include a gyro sensor and the like and may determine whether the user terminal 1 is tilted in the first direction or in the second direction using the gyro sensor and the like.

The user terminal 1 may determine whether the detected motion is a motion of moving to an upper screen (S2222). In an embodiment, a motion of moving to an upper screen may be the second motion, and a motion of moving to a lower screen may be the first motion.

When it is determined that the detected motion is a motion of moving to an upper screen (e.g., the second motion), the user terminal 1 may determine that a preview screen of a depth (i.e., n−1) higher than the current n-depth is selected (S2223).

On the other hand, when it is determined that the detected motion is a motion of moving to a lower screen (e.g., the first motion), the user terminal 1 may determine that a preview screen of a depth (i.e., n+1) lower than the current n-depth is selected (S2224).

FIG. 13 is a diagram illustrating detection of a motion of moving to an upper screen (e.g., the second motion). As illustrated in FIG. 13, when the motion of moving to the upper screen is detected, a preview screen of the immediately previous depth (i.e., a depth one level higher) may be displayed.

According to this embodiment, by changing a preview screen on the basis of the motion of the user terminal 1, it is possible to enhance user convenience in moving the preview screen.

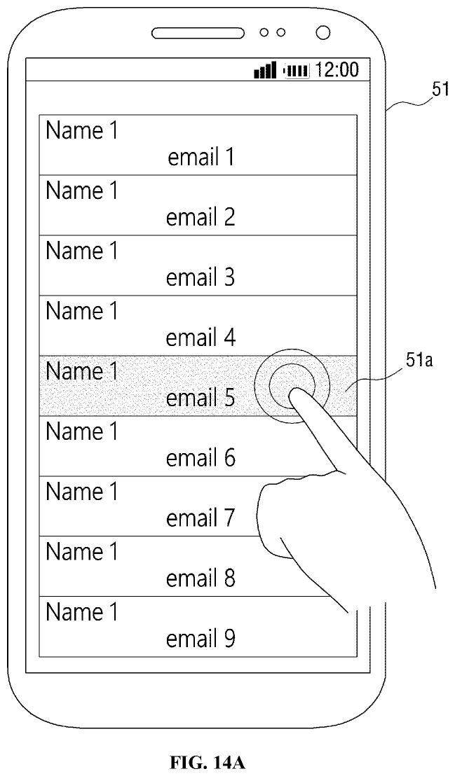

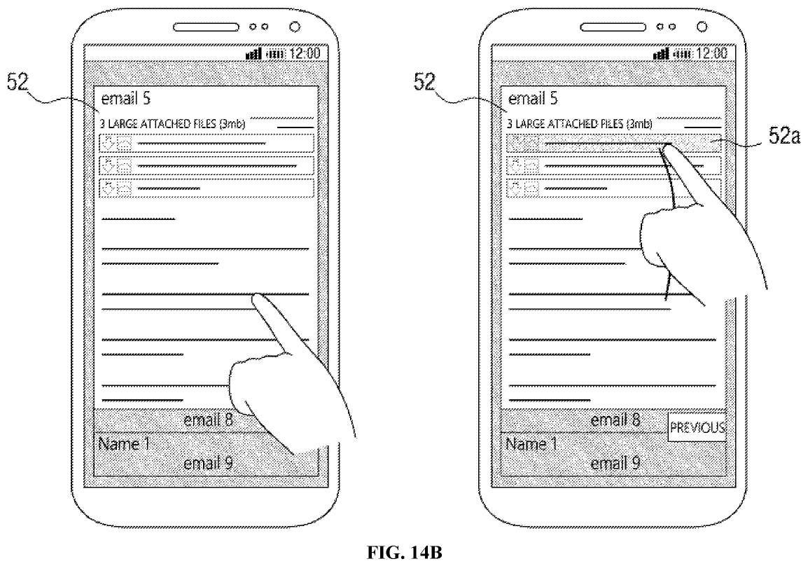

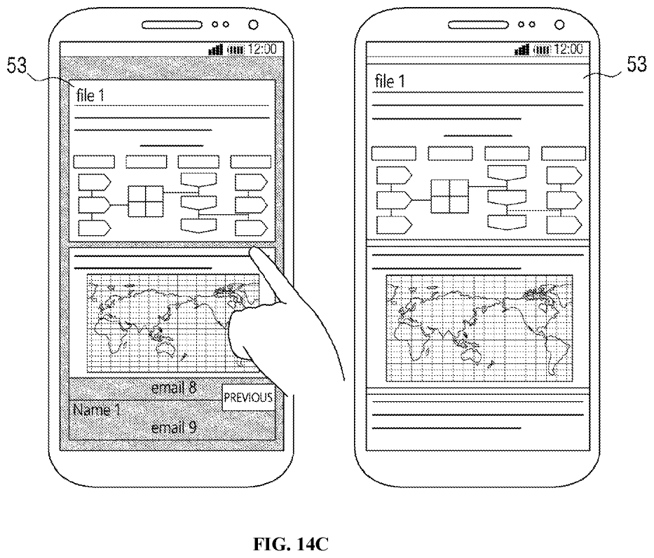

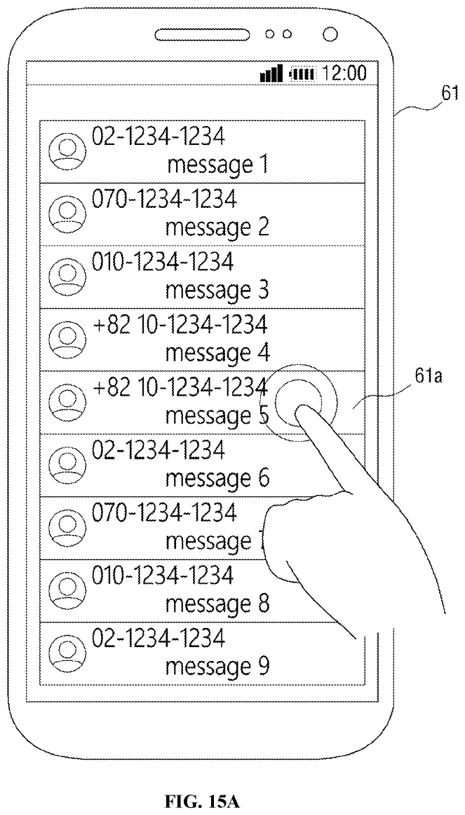

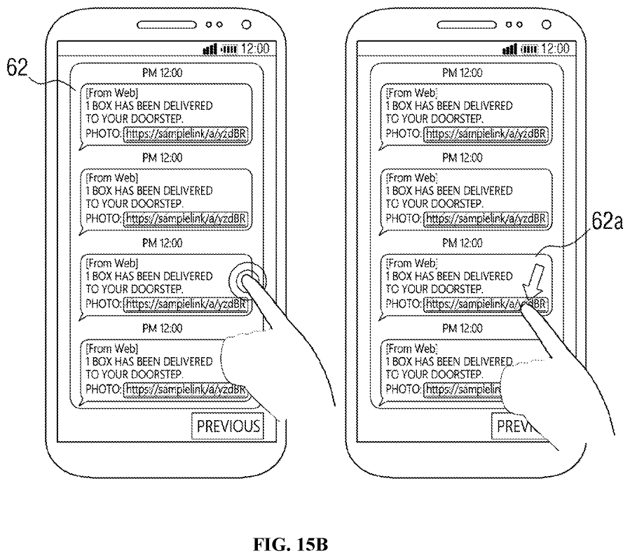

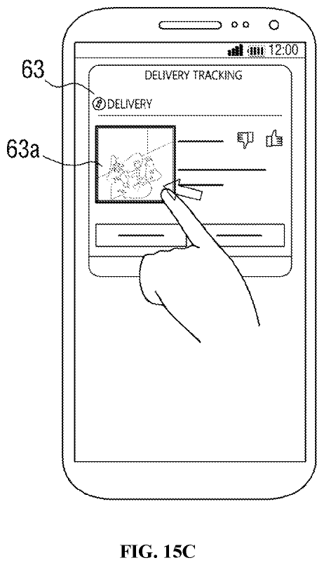

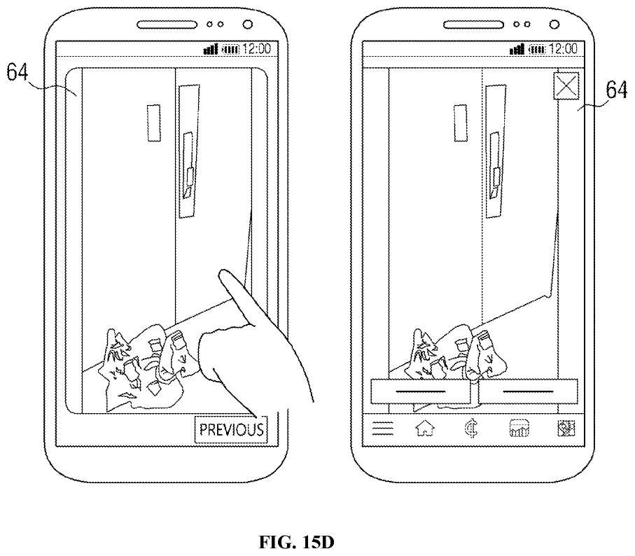

Various examples of a content preview method will be described below with reference to FIGS. 14A to 14C and 15.

FIGS. 14A to 14C are diagrams illustrating application of a content preview method to an email.

In FIG. 14A, a 0-depth content screen 51 may be displayed. When a preview touch gesture for a 1-depth email item 51a is input to the 0-depth content screen 51 (i.e., an email list), a preview screen 52 for the 1-depth email may be displayed in the preview area, as shown in FIG. 14B. Subsequently, a touch input of a swipe to an attached file 52a among 2-depth content items included in the 1-depth email may be performed, and a preview event for the attached file 52a may be generated. In this case, a 3-depth preview screen 53 including detailed information on the attached file as shown in FIG. 14C may be displayed in the preview area. When the touch input of the attached file on the preview screen 53 is not maintained, the 3-depth preview screen 53 may be displayed on the full screen.

FIGS. 15A to 15D are diagrams illustrating application of a content preview method to a chat message.

In FIG. 15A, a chat list 61 of a 0-depth text message may be displayed. When a preview touch gesture for a 1-depth chat item 61a is input to the 0-depth content screen 61 (i.e., a chat list), a preview screen 62 including the 1-depth chat content as shown in FIG. 15B may be displayed in the preview area. Subsequently, a touch input of a swipe to a URL item 62a among 2-depth content items included in the 1-depth chat may be performed, and a preview event for the URL may be generated. In this case, as shown in FIG. 15C, a 3-depth preview screen 63 including detailed information on content linked to the URL may be displayed in the preview area. Subsequently, when a touch input of a swipe to an image item 63a included in the 3-depth preview screen 63 is performed and a preview event for the image item is generated, a 4-depth preview screen 64 including a corresponding image may be displayed in the preview area as shown in FIG. 15D. When the touch input on the 4-depth preview screen 64 is not maintained, the 4-depth preview screen 64 may be displayed on the full screen.

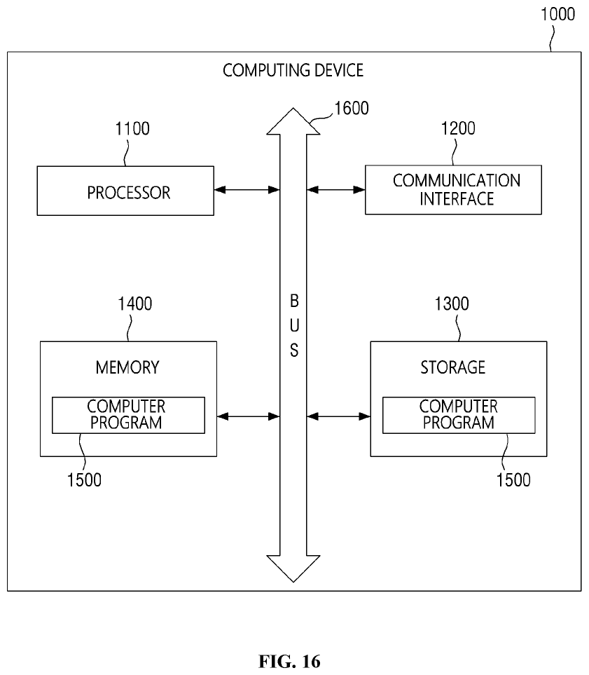

A hardware configuration of an exemplary computing device according to some embodiments will be described below with reference to FIG. 16.

FIG. 16 is a hardware configuration diagram of an exemplary computing device 500.

The computing device 1000 may include one or more processors 1100, a bus 1600, a communication interface 1200, a memory 1400, which loads a computer program 1500 executed by the processors 1100, and a storage 1300 for storing the computer program 1500. However, FIG. 16 illustrates only the components related to the embodiment of the present disclosure. Therefore, it will be appreciated by those skilled in the art that the present disclosure may further include other general purpose components in addition to the components shown in FIG. 16.

The processor 1100 controls overall operations of each component of computing device 1000. The processor 1100 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 1100 may perform calculations on at least one application or program for executing a method/operation according to various embodiments of the present disclosure. The computing device 1000 may have one or more processors.

The memory 1400 stores various data, instructions and/or information. The memory 1400 may load one or more programs 1500 from the storage 1300 to execute methods/operations according to various embodiments of the present disclosure. An example of the memory 1400 may be a RAM, but is not limited thereto.

The bus 1600 provides communication between components of computing device 1000. The bus 1600 may be implemented as various types of bus such as an address bus, a data bus and a control bus.

The communication interface 1200 supports wired and wireless internet communication of the computing device 1000. The communication interface 1200 may support various communication methods other than internet communication. To this end, the communication interface 1200 may be configured to include a communication module well known in the art of the present disclosure.

The storage 1300 can non-temporarily store one or more computer programs 1500. The storage 1300 may be configured to include a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1500 may include one or more instructions, on which the methods/operations according to various embodiments of the present disclosure are implemented. When the computer program 1500 is loaded on the memory 1400, the processor 1100 may perform the methods/operations in accordance with various embodiments of the present disclosure by executing the one or more instructions. A computer program 1500 may include one or more instructions for the methods described with reference to FIGS. 2 to 15D.

The computer program 1500 may include instructions for performing an operation of displaying a first preview screen for first content according to an input of a preview touch gesture, an operation of detecting a preview event for a second content item included in the first preview screen while the touch input is maintained; and an operation of displaying a second preview screen including detailed information on the second content in response to the detection of the preview event.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A content preview method performed by a computing device, the content preview method comprising:
displaying a content list including a first content;
receiving an input of a touch gesture for previewing an subitem of the first content;
displaying a first preview screen for previewing the subitem according to the input of the touch gesture;
detecting a preview event for the subitem included in the first preview screen while the input of the touch gesture is maintained; and
displaying a second preview screen including detailed information on the subitem in response to the detection of the preview event.

2. The content preview method of claim 1, wherein the detecting of the preview event comprises:
receiving a touch input of swiping to the subitem included in the first preview screen while the touch input is maintained; and
determining that the preview event is detected when the touch input is maintained for a predetermined period of time.

3. The content preview method of claim 2, wherein the detecting of the preview event comprises visually displaying a touch input time for the subitem.

4. The content preview method of claim 3, wherein the visually displaying of the touch input time comprises visually expressing a progress rate with respect to the touch input time, which has to be maintained for the preview event to be generated, on a border of the subitem.

5. The content preview method of claim 1, wherein the detecting of the preview event comprises:
receiving a touch input of swiping to the subitem included in the first preview screen while the touch input is maintained; and
determining that the preview event is detected when a first motion is detected while the touch input of swiping to the subitem is maintained.

6. The content preview method of claim 5, wherein the first motion is a motion in which the computing device is tilted in a first direction.

7. The content preview method of claim 1, wherein the detecting the preview event comprises:
receiving a touch input of swiping to the subitem included in the first preview screen while the touch input is maintained; and
determining that the preview event is detected when a three-dimensional (3D) touch input for the subitem is received.

8. The content preview method of claim 1, further comprising:
detecting a second motion when the second preview screen is displayed; and
displaying the first preview screen in response to the detection of the second motion.

9. The content preview method of claim 8, wherein the second motion is a motion in which the computing device is tilted in a second direction.

10. A content preview method performed by a computing device, the content preview method comprising:
displaying an n^{th}-order preview screen for n-depth content where n is a natural number;
detecting a preview event for an (n+1)-depth content item included in the preview screen; and
displaying an (n+1)^{th}-order preview screen including detailed information on (n+1)-depth content in response to the detection of the preview event.

11. The content preview method of claim 10, wherein the detecting of the preview event comprises:
receiving a touch input of swiping to the (n+1)-depth content item included in the n^{th}-order preview screen while the touch input is maintained; and
determining that the preview event is detected when the touch input of swiping to the (n+1)-depth content item is maintained for a predetermined period of time.

12. The content preview method of claim 10, further comprising:
displaying a menu for moving to each of preview screens;
identifying a preview screen selected from the menu; and
displaying the identified preview screen.

13. The content preview method of claim 12, wherein the displaying of the menu comprises, when the menu is touched, spreading out a plurality of options for selecting the preview screens in a predetermined area; and
the identifying of the preview screen comprises selecting one of the plurality of options.

14. The content preview method of claim 10, wherein the detecting of the preview event comprises:
detecting a motion related to preview screen movement;
displaying a preview screen of a lower depth than a depth of a currently displayed preview screen when the detected motion is determined as a first motion; and
displaying a preview screen of a higher depth than the depth of the currently displayed preview screen when the detected motion is determined as a second motion.

15. The content preview method of claim 11, further comprising:
identifying a last touched preview screen when the touch input is terminated; and
displaying the identified preview screen on the full screen.

16. A computing device comprising:
one or more processors;
a memory configured to load a computer program performed by the processors; and
a storage configured to store the computer program,
wherein the computer program comprises instructions for performing operations of:
displaying a content list including a first content;
receiving an input of a touch gesture for previewing an subitem of the first content;
displaying a first preview screen for previewing the subitem according to an input of the touch gesture;
detecting a preview event for the subitem included in the first preview screen while the input of the touch gesture is maintained; and
displaying a second preview screen including detailed information on the subitem in response to the detection of the preview event.

17. The computing device of claim 16, wherein the operation of detecting the preview event comprises operations of:
receiving a touch input of swiping to the subitem included in the first preview screen while the touch input is maintained; and
determining that the preview event is detected when the touch input is maintained for a predetermined period of time.

18. The computing device of claim 17, wherein the operation of detecting the preview event comprises an operation of visually displaying a touch input time for the subitem.

19. The computing device of claim 18, wherein the operation of visually displaying the touch input time comprises an operation of visually expressing a progress rate with respect to the touch input time, which has to be maintained for the preview event to be generated, on a border of the subitem.

20. The computing device of claim 16, wherein the operation of detecting the preview event comprises operations of:
receiving a touch input of swiping to the subitem included in the first preview screen while the touch input is maintained; and
determining that the preview event is detected when a first motion is detected while a touch input of swiping to the subitem is maintained.
